(19) United States
(12) Patent Application Publication
(10) Pub. No.: US 2005/0151918 A1
(43) Pub. Date: Jul. 14, 2005

(54) Display apparatus

(76) Inventors: Jin-Hee Park, Seoul (KR); Eung-Sang Lee, Seoul (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 11/031,909

(22) Filed: Jan. 7, 2005

(30) Foreign Application Priority Data
Jan. 9, 2004 (KR) 2004-01486

(51) Int. Cl. G02F 1/1345

(52) U.S. Cl. 349/150

(57) ABSTRACT

A display apparatus includes first and second display panels, a driver chip and a flexible printed circuit board. The driver chip disposed on the first display panel provides the first display panel with first and second driving signals. The flexible pcb electrically connects the first and second display panels to transfer the first and second driving signals to the second display panel. Each of the first and second display panels includes lower and upper substrates, a liquid crystal interposed between the lower and upper substrates, a combining member combining the lower and upper substrates and has an opening portion formed between sides of the lower and upper substrates, and a sealing member sealing the opening portion. By using a single chip to drive both LCD panels, both size reduction and yield/productivity increase are achieved.

### CROSS-REFERENCE TO RELATED APPLICATIONS

This application relies for priority upon Korean Patent Application No. 2004-1486 filed on Jan. 9, 2004, the content of which is herein incorporated by reference in its entirety.

### BACKGROUND OF THE INVENTION

1. Field of the Invention

The present invention relates to a display apparatus. More particularly, the present invention relates to a compact display apparatus with enhanced manufacturability.

2. Description of the Related Art

Today, a mobile phone is typically available in one of two designs: a non-flip phone and a flip phone. A non-flip phone has a non-foldable body with a liquid crystal display (LCD) panel and input keys that are exposed. A flip phone, on the other hand, has a display part and an input part that are hinged together to allow folding. The display part includes the LCD panel and the input part includes the keys for user input.

When not in use, the display part and the input part are snapped shut for a more compact overall shape. A user uses the phone by unfolding the phone and using the input keys.

The flip phone has one LCD panel or two LCD panels, depending on the model. A phone that has two panels has typically has a main panel and a sub-panel. The sub-panel is used primarily to display a predefined set of non-user-interactive images such as time, date, etc. The images that are displayed in the sub-panel are herein referred to as stand-by images or “sub-images.” Other images are displayed on the main LCD panel.

The display part and the input part of a flip phone are hinged so that the main panel of the display part and the input keys of the input part are located on the inside surfaces that become hidden upon folding. Thus, a user has to unfold the phone to view the images on the main LCD panel. The sub-panel, on the other hand, is disposed on the display part but on the opposite surface of the main panel so that it is visible even when the phone is folded.

While the dual-panel flip phone affords various conveniences, such as being able to check the date and time without unfolding the phone, it is currently more difficult to make and has a lower manufacturability than the non-flip phones. One of the factors contributing to the low manufacturability is the use of two separate chips: a data driver chip and a gate driver chip. The use of two chips complicates the manufacture of a phone, increasing the time it takes to make one phone and generally lowering productivity. Furthermore, the need for two separate chips increases the size of the mobile phone.

A method of producing dual-panel type flip phones without relying on separate chips for the plurality of panels would not only lower the defect rates on these phones but also decrease their size.

### SUMMARY OF THE INVENTION

In one aspect, the invention is a display apparatus that includes a first display panel, a second display panel, a driver chip, and a flexible printed circuit board. The first display panel displays a first image based on a first driving signal, and the second display panel displays a second image based on a second driving signal. The driver chip, which disposed on the first display panel, provides the first display panel with the first and second driving signals. The flexible printed circuit board electrically connects the first and second display panels to transfer the second driving signal from the first display panel to the second display panel. Each of the display panels includes: an upper substrate, a lower substrate, a combining member, liquid crystals, and a sealing member. The lower substrate faces the upper substrate and a first side portion of the lower substrate has the flexible printed circuit board. The combining member is located between and combines the lower and upper substrates. The combining member, the lower substrate, and the upper substrate form a space for liquid crystals, wherein the combining member has an opening portion formed at a second side portion of the lower substrate where there is no the flexible printed circuit board inject the liquid crystals into the space. Liquid crystals in the space are contained with the sealing member that seals the opening portion.

In another aspect, the invention is a display apparatus that includes a first display panel, a second display panel, and a driver chip. The first display panel displays a first image based on a first driving signal. The second display panel that is electrically connected to the first display panel and displays a second image based on a second driving signal. Each of the first and second display panels includes an upper substrate and a lower substrate facing the upper substrate. A combining member located between the lower and upper substrates combines the two substrates such that the combining member, the lower substrate, and the upper substrate form a space for liquid crystals. The combining member has an opening portion formed at a side portion of the lower substrate to inject the liquid crystals into the space, the side portion being aligned with a side portion of the upper substrate. Liquid crystals in the space are contained by a sealing member that seals the opening portion. The display apparatus includes a driver chip that is disposed on the first display panel. The driver chip provides the first display panel with the first and second driving signals.

In yet another aspect, the invention is a display apparatus that includes a first display panel, a second display panel, a driver chip, and a flexible printed circuit board. The first display panel displays a first image based on a first driving signal, and the second display panel displays a second image based on a second driving signal. The driver chip is disposed on the first display panel, and provides the first display panel with the first and second driving signals. The flexible printed circuit board has a first end portion that attached to a first surface of the first display panel and a second end portion that is attached to a first surface of the second display panel, and electrically connects the first and second display panels to transfer the second driving signals from the first display panel to the second display panel. Each of the first and second display panels includes a lower substrate, an upper substrate, a liquid crystal layer interposed between the lower and upper substrates, and a combining member that combines the lower and upper substrates. The lower substrate faces the upper substrate and the first side portion of the lower substrate is attached to the flexible printed circuit board. The combining member has an opening portion formed at a second side portion of the lower substrate where the flexible printed circuit board is not attached. This opening is sealed by a sealing member.

In another aspect, the invention is a display apparatus that includes a display panel that displays an image based on a driving signal and a flexible printed circuit board that is electrically connected to the display panel and transfers the driving signal. The display panel includes an upper substrate, a lower substrate, a liquid crystal layer, and a combining member. The lower substrate faces the upper substrate and the first side portion of the lower substrate is attached to the flexible printed circuit board. The liquid crystal layer is interposed between the lower and upper substrates. The combining member that is located between the lower and upper substrates and combines the two substrates. The combining member has an opening portion formed at a second side portion of the lower substrate where the flexible printed circuit board is not attached. The opening portion is sealable with a sealing member.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a schematic view of a liquid crystal display apparatus employing a dual panel type mobile phone, according to an exemplary embodiment of the present invention;

FIG. 2A is a schematic cross-sectional view taken along a line I-I′ in FIG. 1;

FIG. 2B is a schematic cross-sectional view taken along a line II-II′ in FIG. 1;

FIG. 3 is a block diagram illustrating the display apparatus of FIG. 1;

FIG. 4 is a schematic view illustrating a connection between the two panels of FIG. 1;

FIGS. 5A and 5B are schematic views of LCD panel substrates;

FIG. 6A is a schematic cross-sectional view taken along a line IlI-III′ in FIG. 5A; and

FIG. 6B is a schematic cross-sectional view taken along a line IV-IV′ in FIG. 5B.

### DETAILED DESCRIPTION OF PREFERRED EMBODIMENTS

Hereinafter, the embodiments of the present invention will be described in detail with reference to the accompanied drawings.

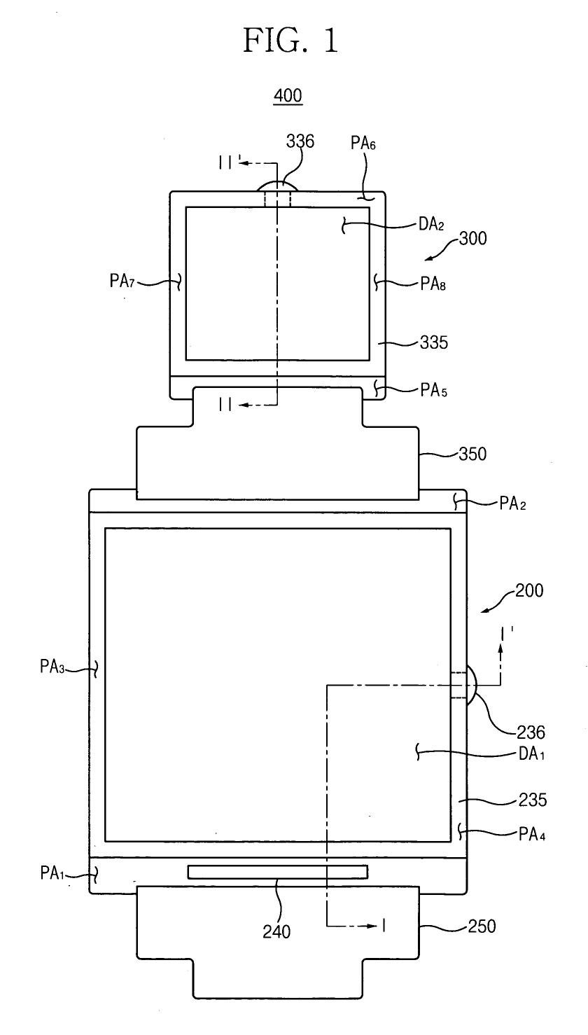

FIG. 1 is a schematic view of a liquid crystal display apparatus employing a dual panel type mobile phone, according to an exemplary embodiment of the present invention.

Referring to FIG. 1, a liquid crystal display apparatus according to the present embodiment includes a main panel 200, a sub-panel 300, and a driver chip 240. The main panel 200 displays main images. The sub-panel 300 displays sub-images, which typically include non-user-interactive data such as time, date, etc. The driver chip 240 drives the main and sub-panels 200 and 300.

The main panel 200 includes a first display region DA1, a first peripheral region PA1, a second peripheral region PA2, a third peripheral region PA3 and a fourth peripheral region PA4. The first peripheral region PA1 and the second peripheral region PA2 are separated by the main panel 200, and the third peripheral region PA3 and the fourth peripheral region PA4 are separated from each other by the main panel 200.

The first display region DA1 displays the main images. The first to fourth peripheral regions PA1 to PA4 surround the first display region DA1. The sub-panel 300 includes a second display region DA2, a fifth peripheral region PA5, a sixth peripheral region PA6, a seventh peripheral region PA7 and an eighth peripheral region PA8. The second display region DA2 displays the sub-images. The fifth to eighth peripheral regions PA5 to PA8 surround the second display region DA2. The fifth peripheral region PA5 of the sub panel 300 is adjacent to the second peripheral region PA2 of the main panel 200. The fifth peripheral region PA5 and the sixth peripheral region PA6 are separated from each other by the sub-panel 300, and the seventh peripheral region PA7 and the eighth peripheral region PA8 are separated from each other by the sub-panel 300.

Preferably, the main panel 200 is bigger than the sub-panel 300 and the first display region DA1 is bigger than the second display region DA2.

The driver chip 240 is disposed on the first peripheral region PA1. The display apparatus 400 further includes a first flexible printed circuit board 250 and a second flexible printed circuit board 350. A first end portion of the first flexible printed circuit board 250 is attached to the first peripheral region PA1. A first end portion of the second flexible printed circuit board 350 is attached to the second peripheral region PA2, and a second end portion of the second flexible printed circuit board 350 is attached to the fifth peripheral region PA5. The main and sub panels 200 and 300 are electrically connected to each other through the second flexible printed circuit board 350.

The driver chip 240 formed on the first peripheral region PA1 is also electrically connected to the sub-panel 300 through the second flexible printed circuit board 350.

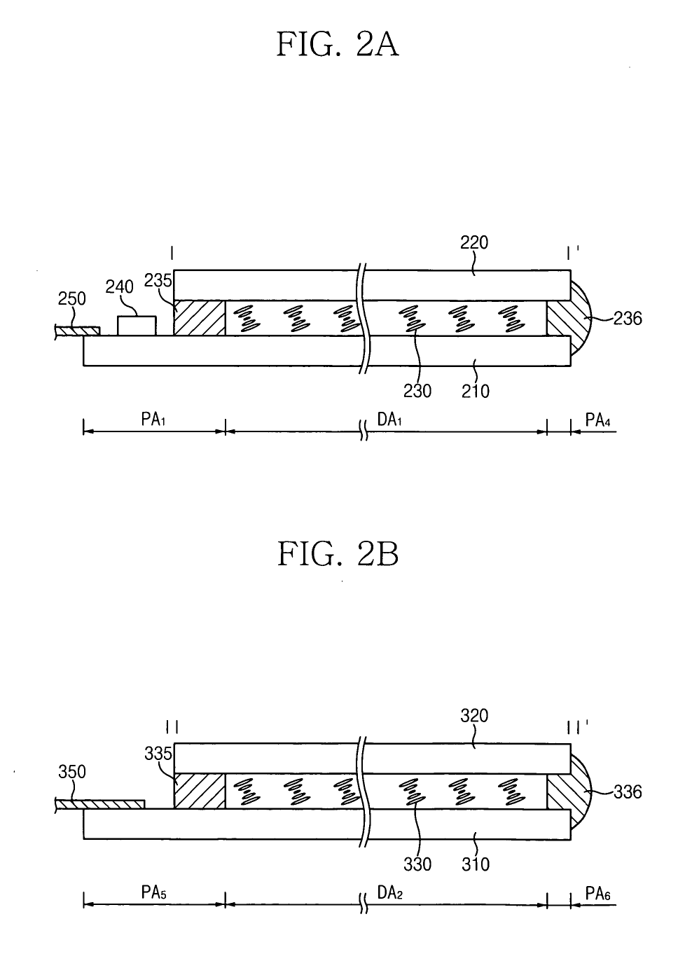

FIG. 2A is a schematic cross-sectional view taken along a line I-I′ in FIG. 1, and FIG. 2B is a schematic cross-sectional view taken along a line II-II′ in FIG. 1.

Referring to FIGS. 1 and 2A, the main panel 200 includes a first lower substrate 210, a first upper substrate 220, a first liquid crystal layer 230 interposed between the first lower substrate 210 and the first upper substrate 220, and a first combining member 235 that combines the first lower substrate 210 and the first upper substrate 220.

As shown in FIG. 2A, the first lower substrate 210 is longer than the first upper substrate 220. The driver chip 240 is mounted on the first peripheral region PA1 of the first lower substrate 210. The first end of the first flexible printed circuit board 250 is attached to the first peripheral region PA1 such that the first flexible printed circuit board 250 is adjacent to the driver chip 240. Additionally, the first end of the second flexible printed circuit board 350 is attached to the second peripheral region PA2.

The first lower substrate 210 and the first upper substrate 220 have substantially the same width (a “width” is measured along a horizontal line across FIG. 1), so that the third and fourth peripheral regions PA3 and PA4 of the first lower substrate 210 correspond to the third and fourth peripheral regions PA3 and PA4 of the first upper substrate 220, respectively. The boundaries that define the third and fourth peripheral regions PA3 and PA4 on the first lower substrate 210 are aligned with the boundaries that define the same peripheral regions PA3 and PA4 on the first upper substrate 220. Thus, the edges of the third and fourth peripheral regions PA3 and PA4 of the first lower substrate 210 are aligned with the edges of the third and fourth peripheral regions PA3 and PA4 of the first upper substrate 220. If one were to imagine a virtual plane touching an edge of the first lower substrate 210 and a corresponding edge of the first upper substrate 220 (e.g., the outer edges of the third peripheral regions PA3 in both substrates), the virtual plane would form an approximately 90°-angle with respect to the surfaces of the first lower substrate 210 and the first upper substrate 220 that interface the liquid crystal layer.

The first combining member 235 is disposed in the first, second, third and fourth peripheral regions PA1, PA2, PA3 and PA4 and surrounds the first display region DA1. Thus, when the first combining member 235 is put together with the first lower substrate 210 and the first upper substrate 220, a space is formed corresponding to the first display region DA1. The first combining member 235 of the fourth peripheral region PA4 includes an opening portion through which liquid crystals may be added (e.g., injected) into this space.

A first sealing member 236 may be used to fill the opening portion to prevent the liquid crystals from leaking out. In the particular embodiment shown, this opening portion is in the fourth peripheral region PA4. Alternatively, the opening portion may be formed in the third peripheral region PA3. There may be one or more opening portions, depending on the embodiment. The first sealing member 236 may include the same the material as the first combining member 235. The first sealing member 236 covers or seals the opening portion(s), creating an enclosed space that contains the liquid crystals.

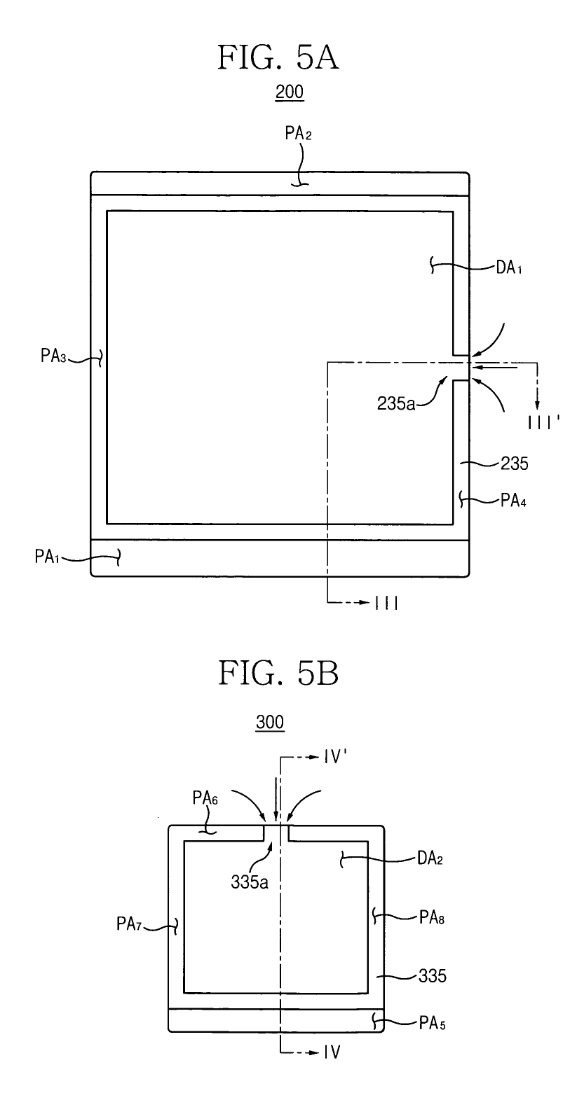

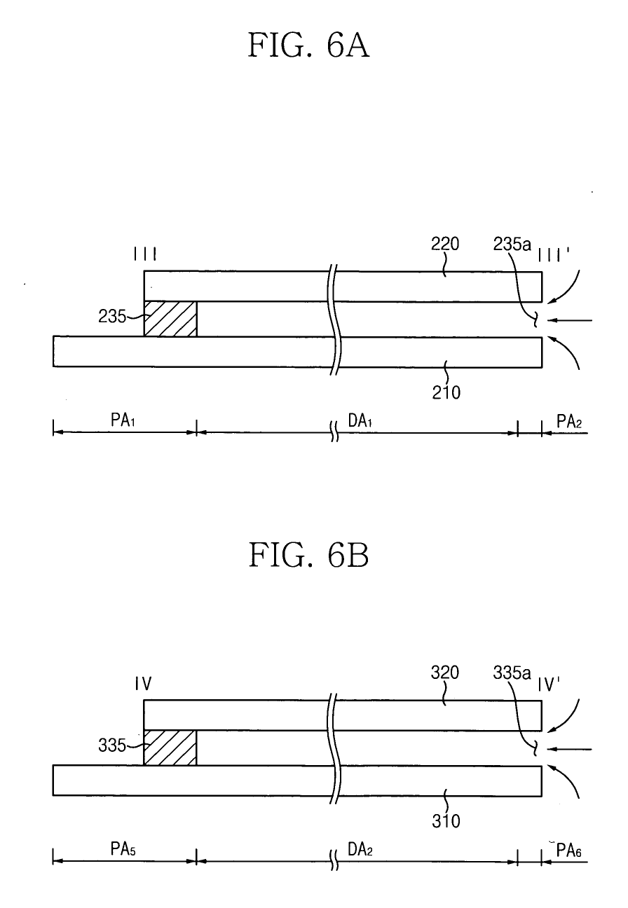

The first combining member 235 will be explained in detail referring to FIGS. 5A and 6A.

Referring to FIGS. 1 and 2B, the sub-panel 300 includes a second lower substrate 310, a second upper substrate 320, a second liquid crystal layer 330 interposed between the second lower substrate 310 and the second upper substrate 320, and a second combining member 335 that combines the second lower substrate 310 and the second upper substrate 320.

The second lower substrate 310 is longer than the second upper substrate 320.

The second end of the second flexible printed circuit board 350 is attached to the fifth peripheral region PA5. As mentioned above, the first end of the second flexible printed circuit board 350 is attached to the second peripheral region PA2. Thus, the second flexible printed circuit board 350 electrically couples the first main panel 200 to the sub-panel 300.

The second lower substrate 310 and the second upper substrate 320 have substantially the same width, so that the seventh and eighth peripheral regions PA7 and PA8 of the second lower substrate 310 correspond to the seventh and eighth peripheral regions PA7 and PA8 of the second upper substrate 320, respectively. Additionally, the sixth peripheral region PA6 of the second lower substrate 310 corresponds to the sixth peripheral region PA6 of the second upper substrate 320. The boundaries that define the sixth, seventh, and eighth peripheral regions PA6, PA7, and PA8 in the second lower substrate 310 are substantially aligned with the boundaries that define the same regions PA6, PA7, and PA8 in the second upper substrate 320. That is, the edges of the sixth, seventh, and eighth peripheral regions PA6, PA7, and PA8 of the second lower substrate 310 are aligned with the edges of the sixth, seventh and eighth peripheral regions PA6, PA7 and PA8 of the second upper substrate 320. Thus, if one were to imagine a virtual plane touching an edge of the first lower substrate 310 and a corresponding edge of the first upper substrate 320 (e.g., the outer edges of the six peripheral region PA6 in both substrates), the virtual plane would form an approximately 90°-angle with respect to the surfaces of the first lower substrate 210 and the first upper substrate 220 that interface the liquid crystal layer.

The second combining member 335 is disposed in the fifth, sixth, seventh, and eighth peripheral regions PA5, PA6, PA7 and PA8 such that the second combining member 335 surrounds the second display region DA2. Thus, when the second combining member 335 is assembled with the second lower substrate 310 and the first lower substrate 320, a space that corresponds to the second display region DA2 is formed. The second combining member 335 of the sixth peripheral region PA6 includes an opening portion through which liquid crystals may be injected into this space.

A second sealing member 336 is disposed at an opening portion of the second combining member 335 of the sixth peripheral region PA6. The second sealing member 336 may include the same material as the second combining member 335. The second sealing member 336 covers or seals the opening portion(s).

The second combining member 335 will be explained in detail in reference to FIGS. 5B and 6B.

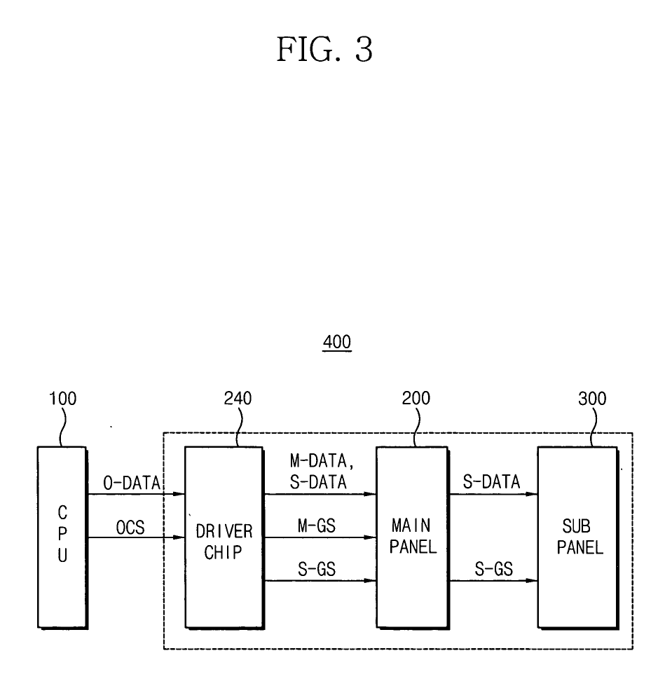

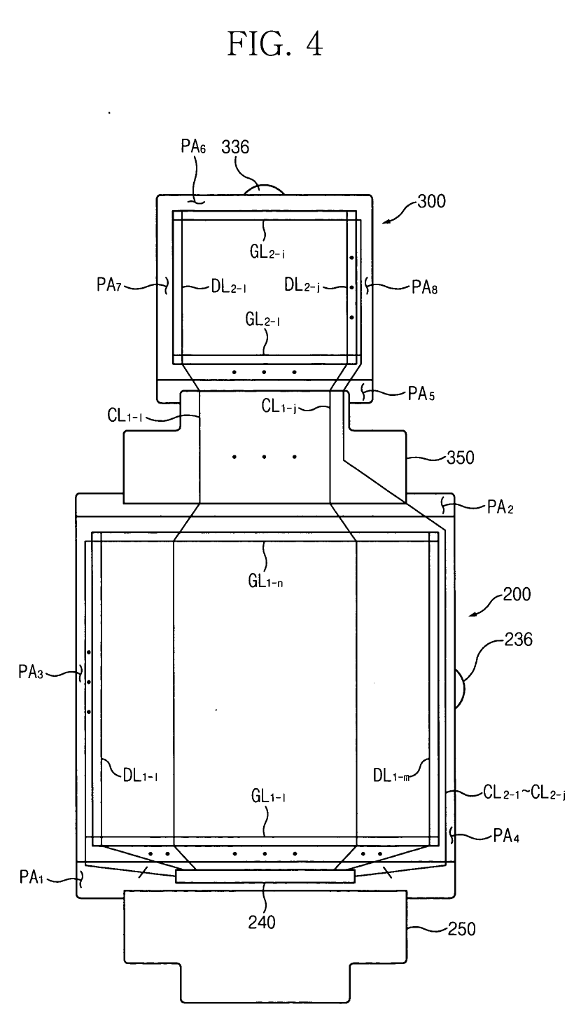

FIG. 3 is a block diagram illustrating the display apparatus of FIG. 1, and FIG. 4 is a schematic view illustrating a connection between the main panel and the sub-panel of FIG. 1.

Referring to FIGS. 2A, 2B, and 3, the driver chip 240 receives a primitive data signal O-DATA and a primitive control signal OCS from an external apparatus, for example a central processing unit (CPU).

The driver chip 240 applies signals such as main data signals M-DATA, sub data signals S-DATA, main gate signals M-GS and sub gate signals S-GS to the main panel 200 based on the primitive data signal O-DATA and the primitive control signal OCS.

The main panel 200 receives the main data signals M-DATA and the sub data signals S-DATA through a first path from the driver chip 240. The main panel 200 also receives the main gate signals M-GS and the sub gate signals S-GS through second and third paths, respectively, from the driver chip 240.

The main panel 200 displays main images based on the main data signals M-DATA and the main gate signals M-GS. The sub data signals S-DATA and the sub gate signals S-GS are applied to the sub panel 300 through the main panel 200. Therefore, the sub-panel 300 displays the sub-images based on the sub data signals S-DATA and the sub gate signals S-GS.

Referring to FIG. 4, the main panel 200 includes a first gate line group having a plurality of first gate lines GL₁₋₁, GL₁₋₂, . . . , GL₁₋ₙ, and a first data line group having a plurality of first data lines DL₁₋ₐ, DL₁₋₂, . . . , DL₁₋ₘ. The first gate lines GL₁₋₁, GL₁₋₂, . . . , GL1-n and the first data lines DL₁₋₁, D₁₋₂, . . . , DL₁₋ₘ are formed on the first display region DA1, wherein ‘m’ and ‘n’ are integers greater than 1. Each of the first gate lines GL₁₋₁, GL₁₋₂, . . . , GL₁₋ₙ is substantially perpendicular to each of the first data lines DL1-1, DL₁₋₂, . . . , D₁₋ₘ.

The sub panel 300 includes a second gate line group having a plurality of second gate lines GL₂₋₁, GL₂₋₂, . . . , GL₂₋ᵢ, and a second data line group having a plurality of second data lines DL₂₋₁, DL₂₋₂, . . . , DL₂₋ⱼ, wherein ‘i’ is an integer greater than one and equal to or less than ‘n’, and ‘j’ is an integer greater than one and equal to or less than ‘m’. The second gate lines GL₂₋₁, GL₂₋₂, . . . , GL₂₋ᵢ and the second data lines DL₂₋₁, DL₂₋₂, . . . , DL₂₋ⱼ are formed on the second display region DA2. Each of the second gate lines GL₂₋₁, GL₂₋₂, . . . , GL₂₋ᵢ is substantially perpendicular to each of the second data lines DL₂₋₁, DL₂₋₂, . . . , DL₂₋ⱼ.

The second flexible printed circuit board 350 includes a first connection line group having a plurality of first connection lines CL₁₋₁, CL₁₋₂, . . . CL₁₋ⱼ, and a second connection line group having a plurality of second connection lines CL₂₋₁, CL₂₋₂, . . . CL₂₋ᵢ. The first connection lines CL₁₋₁, CL₁₋₂, . . . CL₁₋ⱼ electrically connect portions of the first data lines DL₁₋₁, DL₁₋₂, . . . , DL₁₋ₘ to the second data lines DL₂₋₁, DL₂₋₂, . . . , DL₂₋ⱼ. The second connection lines CL₂₋₁, CL₂₋₂, . . . CL₂₋ᵢ electrically connect the driver chip 240 to the second gate lines GL₂₋₁, GL₂₋₂, . . . , GL₂₋ᵢ.

In order to drive the main panel 200, the driver chip 240 applies the main gate signals M-GS to the first gate lines GL₁₋₁, GL₁₋₂, . . . , GL₁₋ₙ, and applies the main data signals M-DATA to the first data lines DL₁₋₁, DL₁₋₂, . . . , DL₁₋ₘ.

In order to drive the sub panel 300, the driver chip 240 applies the sub gate signals S-GS to the second connection lines CL₂₋₁, CL₂₋₂, . . . CL₂₋ᵢ and the driver chip 240 applies the sub data signals S-DATA to the portions of the first data lines DL₁₋₁, DL₁₋₂, . . . , DL₁₋ₘ. The sub gate signals S-GS applied to the second connection lines CL₂₋₁, CL₂₋₂, . . . CL₂₋ᵢ are transferred to the second gate lines GL₂₋₁, GL₂₋₂, . . . , GL₂₋ᵢ of the sub panel 300. The sub data signals S-DATA applied to the portions of the first data lines DL₁₋₁, DL₁₋₂, . . . , DL₁₋ₘ are transferred to the second data lines DL₂₋₁, DL₂₋₂, . . . , DL₂₋ⱼ through the first connection lines CL₁₋₁, CL₁₋₂, . . . , CL₁₋ⱼ, respectively.

The LCD apparatus 400 having two panels (e.g., the main panel 200 and the sub-panel 300) may be driven by one driver chip 240 in the manner described above. Since no separate driver chip is required to drive the sub-panel 300, both the size of the LCD apparatus and the number of defects are reduced.

FIGS. 5A and 5B are schematic views illustrating first and second substrates, respectively. FIG. 6A is a schematic cross-sectional view taken along a line III-III′ in FIG. 5A, and FIG. 6B is a schematic cross-sectional view taken along a line IV-IV′ in FIG. 5B.

Referring to FIGS. 5A and 6A, the first lower substrate 210 and the first upper substrate 220 are combined together by the first combining member 235 in order to form the main panel 200.

The first combining member 235 is formed in the first, second, third and fourth peripheral regions PA1, PA2, PA3 and PA4 such that the first combining member 235 substantially surrounds the first display region DA1. The first combining member 235 of the fourth peripheral region PA4 includes a first opening portion 235a. The first liquid crystal layer 230 in FIG. 2A is injected into a space between the first lower substrate 210 and the first upper substrate 220 through the first opening portion 235a.

The first combining member 235 is made of a heat curable resin or a light curable resin. The first combining member 235 interposed between the first lower substrate 210 and the first upper substrate 220 is cured by heat or light, and the first lower substrate 210 and the first upper substrate 220 are combined by the first combining member 235.

Referring again to FIG. 2A, when the space between the first lower substrate 210 and the first upper substrate 220 is filled with the first liquid crystal layer 230, the first sealing member 236 covers or seals the first opening portion 235a. The first sealing member 236 is made of a heat curable resin or a light curable resin, and the first sealing member 236 comprises a material that is substantially the same as that of the first combining member 235.

Referring to FIGS. 5B and 6B, the second lower substrate 310 and the second upper substrate 320 are combined together by the second combining member 335 in order to form the sub panel 300. The second combining member 335 is formed in the fifth, sixth, seventh and eighth peripheral regions PA5, PA6, PA7 and PA8 such that the second combing member 335 surrounds the second display region DA2. The second combining member 335 of the sixth peripheral region PA6 includes a second opening portion 235a. The first liquid crystal layer 230 in FIG. 2A is injected into a space between the second lower substrate 310 and the second upper substrate 320 through the first opening portion 335a.

The second combining member 335 is made of a heat curable resin or a light curable resin. The second combining member 335 interposed between the second lower substrate 310 and the second upper substrate 320 is cured by heat or light, and the second lower substrate 310 and the second upper substrate 320 are combined by the second combining member 335.

Referring again to FIG. 2B, when the space between the second lower substrate 310 and the second upper substrate 320 is filled with the second liquid crystal layer 330, the second sealing member 336 covers or seals the second opening portion 335a.

The second sealing member 336 is made of a heat curable resin or a light curable resin, and the second sealing member 336 comprises a material that is substantially the same as that of the second combining member 335.

According to the present invention, both of the main panel and the sub panel are driven by one driver chip because the flexible printed circuit board electrically connects the main panel and the sub panel. Therefore, the size of the LCD apparatus is reduced. Further, this single-chip configuration eliminates the driver chip mounting process for the sub-panel, thus reducing the total number of defects and enhancing productivity.

Furthermore, the first opening portion 235a is formed at the third or fourth peripheral region. The opening portion 235a facilitates the injection of the first liquid crystal into the panels, and thereby enhances the yield or manufacturing productivity.

Having described the exemplary embodiments of the present invention and its advantages, it is noted that various changes, substitutions and alterations can be made herein without departing from the spirit and scope of the invention as defined by appended claims.

1. A display apparatus comprising:
a first display panel that displays a first image based on a first driving signal;
a second display panel that displays a second image based on a second driving signal;
a driver chip disposed on the first display panel, the driver chip providing the first display panel with the first and second driving signals; and
a flexible printed circuit board that electrically connects the first and second display panels to transfer the second driving signal from the first display panel to the second display panel,
wherein each of the first and second display panels includes:
an upper substrate and a lower substrate facing the upper substrate, a first side portion of the upper and lower substrates having the flexible printed circuit board;
a combining member located between and combining the lower and upper substrates such that the combining member, the lower substrate, and
the upper substrate form a space for liquid crystals, wherein the combining
member has an opening portion formed at a second side portion of the upper and lower substrates where there is no the flexible printed circuit board to inject the liquid crystals into the space;
liquid crystals in the space; and
a sealing member that seals the opening portion.

2. The display apparatus of claim 1, wherein the first display panel includes first data lines extending along a first direction and first gate lines extending along a second direction that is substantially perpendicular to the first direction, the first display panel transmitting the first driving signals from the driver chip to the second display panel, and wherein the second display panel includes second data lines extending along the first direction and second gate lines extending along the second direction.

3. The display apparatus of claim 2, wherein the lower substrate extends to form a first region that is not covered by the upper substrate, and the driver chip is disposed on the first region.

4. The display apparatus of claim 3, wherein the flexible printed circuit board is attached to a second region of the first display panel and a third region of the second display panel such that the flexible printed circuit board electrically connects at least some of the first data lines to the second data lines.

5. The display panel of claim 1, wherein the sealing member comprises a material that is substantially the same as that of the combining member.

6. A display apparatus comprising:
a first display panel that displays a first image based on a first driving signal;
a second display panel that is electrically connected to the first display panel and displays a second image based on a second driving signal; and
a driver chip disposed on the first display panel, the driver chip providing the first display panel with the first and second driving signals,
wherein each of the first and second display panels includes:
an upper substrate;
a lower substrate facing the upper substrate;
a combining member located between and combining the lower and upper substrates such that the combining member, the lower substrate, and the upper substrate form a space for liquid crystals, wherein the combining member has an opening portion formed at an side portion of the upper and lower substrates to inject the liquid crystals into the space, the side portion of the upper substrate being aligned with the side portion of the lower substrate having the opening portion;
liquid crystals in the space; and
a sealing member that seals the opening portion.

7. The display apparatus of claim 6, further comprising a flexible printed circuit board that electrically connects the first and second display panels to transfer the second driving signal from the first display panel to the second display panel.

8. The display panel of claim 7, wherein the flexible printed circuit board comprises a first end portion that is attached to an edge portion of the first display panel and a second end portion that is attached to an edge portion of the second display panel.

9. The display apparatus of claim 6, wherein the sealing member comprises a material that is substantially the same as that of the combining member.

10. The display apparatus of claim 6, wherein the second driving signal output from the driver chip is applied to the second display panel via the first display panel.

11. A display apparatus comprising:
a first display panel that displays a first image based on a first driving signal;
a second display panel that displays a second image based on a second driving signal;
a driver chip disposed on the first display panel, the driver chip providing the first display panel with the first and second driving signals; and
a flexible printed circuit board having a first end portion that attached to a first side of the first display panel and a second end portion that is attached to a first side of the second display panel, wherein the flexible printed circuit board electrically connects the first and second display panels to transfer the second driving signals from the first display panel to the second display panel,
wherein each of the first and second display panels includes:
an upper substrate;
a lower substrate facing the upper substrate, a first side of the lower substrate being attached to the flexible printed circuit board;
a liquid crystal layer interposed between the lower and upper substrates;
a combining member that combines the lower and upper substrates and has an opening portion formed at a second side portion of the lower substrate where the flexible printed circuit board is not attached, and
a sealing member that seals the opening portion.

12. The display apparatus of claim 11, wherein the second side of the first display panel is substantially perpendicular to the first side of the first display panel.

13. The display apparatus of claim 11, wherein the second side of the second display panel is substantially parallel with the first side of the second display panel.

14. The display apparatus of claim 11, wherein the first display panel comprises a plurality of first data lines extending in a first direction and a plurality of first gate lines extending in a second direction that is substantially perpendicular to the first direction to receive the first driving signal from the driver chip, and the second display panel comprises a plurality of second data lines extending in the first direction and a plurality of second gate lines extending in the second direction to receive the second driving signal from the driver chip.

15. The display panel of claim 14, wherein the lower substrate of the first display panel extends to form a third side that is substantially parallel to the first side and for which there is no corresponding surface in the upper substrate, and the driver chip is disposed on the third surface.

16. The display panel of claim 15, wherein the lower substrates of the first and second display panels extend beyond the upper substrates of the first and second display panels to define the first sides of the first and second display panels, respectively.

17. The display panel of claim 11, wherein the sealing member comprises a material that is substantially the same as that of the combining member.

18. The display panel of claim 11, wherein the second side portion of the lower substrate is aligned with a side portion of the upper substrate.

19. A display apparatus comprising:
a display panel that displays an image based on a driving signal; and
a flexible printed circuit board that is electrically connected to the display panel and transfers the driving signal,
wherein the display panel includes:
an upper substrate;
a lower substrate facing the upper substrate, a first side portion of the lower substrate being attached to the flexible printed circuit board,
a liquid crystal layer interposed between the lower and upper substrates,
a combining member located between the lower and upper substrates to combine the lower and upper substrates, wherein the combining member has an opening portion formed at a second side portion of the lower substrate where the flexible printed circuit board is not attached, and
a sealing member that seals the opening portion.

20. The display panel of claim 19, wherein the sealing member comprises a material that is substantially the same as that of the combining member.
